(19) United States
(12) Patent Application Publication
(10) Pub. No.: US 2009/0002917 A1
(43) Pub. Date: Jan. 1, 2009

(54) CAPACITOR IN SEMICONDUCTOR DEVICE AND METHOD FOR FABRICATING THE SAME

(75) Inventors: Deok-Sin KIL, Ichon-shi (KR); Kee-Jeung Lee, Ichon-shi (KR); Han-Sang Song, Ichon-shi (KR); Young-Dae Kim, Ichon-shi (KR); Jin-Hyock Kim, Ichon-shi (KR); Kwan-Woo Do, Ichon-shi (KR); Kyung-Woong Park, Ichon-shi (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor Inc., Ichon-shi (KR)

(21) Appl. No.: 11/965,733

(22) Filed: Dec. 28, 2007

(30) Foreign Application Priority Data
Jun. 28, 2007 (KR) 10-2007-0064493

(51) Int. Cl. H01G 4/008; H01G 9/00

(52) U.S. Cl. 361/305; 29/25.03

(57) ABSTRACT

A capacitor includes a lower electrode, a dielectric layer over the lower electrode, and an upper electrode having a stack structure including a ruthenium-containing layer and a tungsten-containing layer over the dielectric layer.

### CROSS-REFERENCE TO RELATED APPLICATIONS

The present invention claims priority of Korean patent application number 10-2007-0064493, filed on Jun. 28, 2007, which is incorporated by reference in its entirety.

### BACKGROUND OF THE INVENTION

The present invention relates to a method for fabricating a semiconductor device, and more particularly, to a method for fabricating a capacitor having an electrode which includes a ruthenium layer.

For the development of a highly integrated dynamic random access memory (DRAM) of 50 nm or less, development of a dielectric layer is needed, wherein the dielectric layer includes one selected from a group consisting of zirconium oxide (ZrO₂), titanium oxide (TiO₂) or niobium oxide (Nb₂O₅) and a combination thereof, which has a greater dielectric constant than an aluminum oxide (Al₂O₃) or an hafnium oxide (HfO₂) layer. Thus, noble metal materials, such as platinum (Pt), ruthenium (Ru) or iridium (Ir), are introduced as an electrode material.

Since the noble metal materials have a great work function, leakage current may be controlled by a leakage current barrier layer on an interface between the electrode and the dielectric layer formed by a work function difference between the electrode material and the dielectric material. Thus, stable leakage current characteristics can be secured. Further, since the electrode may not be easily oxidized and although the electrode may be oxidized, electronic conductive characteristics may be maintained, and a capacitance may be increased due to formation of a thin dielectric layer.

FIG. 1 illustrates a cross-sectional view of a method for fabricating a typical capacitor. A dielectric layer 12 is formed over a first conductive layer 11. The dielectric layer 12 includes one selected from a group consisting of ZrO₂₁ TiO₂ or Nb₂O₅ and a combination thereof. A second conductive layer 13 is formed over the zirconium oxide layer 12, and then the second conductive layer 13 is etched with a hard mask layer 14, thus forming an upper electrode. The second conductive layer 13 includes a ruthenium (Ru) containing layer, such as a ruthenium layer, and the hard mask layer 14 used as an etch barrier for etching the ruthenium layer 13 includes a titanium nitride (TiN) layer.

However when the titanium nitride layer 14 is used as the hard mask, the leakage current characteristics of the capacitor may be is, deteriorated due to deoxidization of the zirconium oxide layer 12 under the ruthenium, layer 13. Since the titanium nitride layer 14 is formed at a temperature of approximately 500° C. with an ammonia (NH₃) gas as a reaction gas, the zirconium oxide layer 12 is deoxidized while the titanium nitride layer 14 is formed over the ruthenium layer 13. If the zirconium oxide layer 12 is exposed in an ammonia atmosphere, electrical characteristics of the zirconium oxide layer 12 may be deteriorated due to its deoxidization.

FIG. 2 illustrates an X-ray photoelectron spectroscopy (XPS) analysis result of ZrO₂ exposed in the ammonia atmosphere. The XPS analysis is a method to analyze elemental composition of, a sample. When the X-ray is applied to the sample, components of the sample absorb the applied X-ray, which then cause the electrons to emit X-rays. Thus, components of the sample may be detected from a binding energy of emitted X-rays.

Referring to FIG. 2, the ZrO₂ exposed at a temperature of approximately 500° C. in the ammonia atmosphere has a lower intensity than the ZrO₂ as deposited. In other words, the lower intensity of the ZrO₂ exposed in the ammonia atmosphere means that the ZrO₂ is deoxidized in the ammonia atmosphere.

### SUMMARY OF THE INVENTION

The present invention is directed to provide a method for fabricating a semiconductor device, and more particularly, to a method for fabricating a capacitor in a semiconductor device, which can prevent a deoxidization of a dielectric layer with a hard mask used for etching of a ruthenium (Ru) containing layer, such as a ruthenium layer.

In accordance with an aspect of the present invention, there is provided a capacitor. The capacitor comprising: a lower electrode, a dielectric layer over the lower electrode; and an upper electrode having a stack structure including a ruthenium containing layer and a tungsten containing layer over the dielectric layer.

In accordance with another aspect of the present invention, there is provided a method for fabricating a capacitor. The method comprising: forming a lower electrode; forming a dielectric layer over the lower electrode; forming a ruthenium containing layer over the dielectric layer; forming a hard mask pattern containing tungsten (W) over the ruthenium containing layer; and partially etching the ruthenium containing layer using the hard mask pattern as an etch barrier, thereby forming an upper electrode.

### BRIEF DESCRIPTION OF THE DRAWINGS

FIG. 1 illustrates a cross-sectional view of a method for fabricating a typical Capacitor.

FIG. 2 illustrates an X-ray photoelectron spectroscopy XPS) analysis result of a zirconium oxide (ZrO₂) exposed in an ammonia atmosphere.

FIGS. 3A and 3B illustrate cross-sectional views of a method for fabricating a capacitor in accordance with the embodiment of the present invention.

FIG. 4 illustrates an order of gases injected to a chamber when forming a tungsten nitride (WN) layer in accordance with an embodiment of the present invention.

FIG. 5 illustrates a growth rate of the tungsten nitride layer according to a substrate temperature.

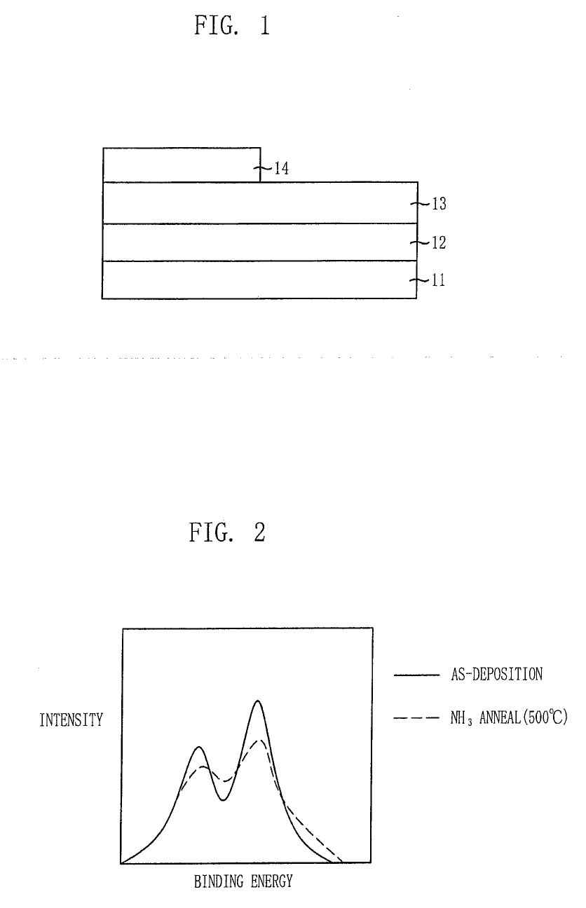

### DESCRIPTION OF SPECIFIC EMBODIMENTS

The present invention relates to a method for forming a pattern in a semiconductor device. According to an embodiment of the present invention, a tungsten nitride (WN) layer is used as an etch barrier during etching of a ruthenium (Ru) containing layer or a ruthenium-based electrode.

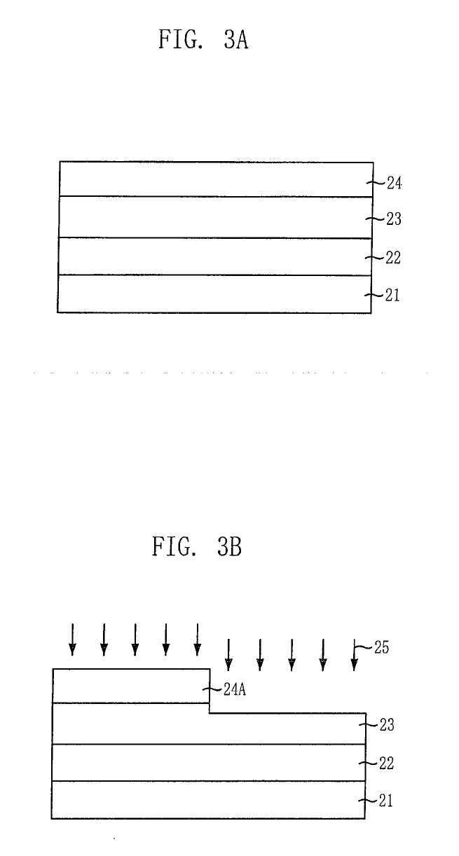

FIGS. 3A and 3B illustrate cross-sectional views of La method for forming a capacitor in accordance with an embodiment of the present invention.

Referring to FIG. 3A, a lower electrode 21 is formed. Although it is not shown, the lower electrode 21 is patterned to have a given shape, wherein the given shape includes a plate type, a concave type or a cylinder type. The lower electrode 21 includes one selected from a group consisting of titanium nitride (TiN), ruthenium (Ru), ruthenium oxide (RuO₂), platinum (Pt), iridium (Ir), iridium oxide (IrO₂) hafnium nitride (HfN), zirconium nitride (ZrN) and a combination thereof. The lower electrode 21 is formed by an atomic layer deposition (ALD) process, a chemical vapor deposition (CVD) process, an electro plating process or a sputtering process. Hereinafter, it is assumed that the lower electrode 21 is a TiN layer.

A dielectric layer 22 is formed over the TiN layer 21, The dielectric layer 22 includes one selected from a group consisting of ZrO₂, hafnium oxide (HfO₂), aluminum oxide (Al₂O₃), strontium titanate, (SrTiO₃), barium-strontium titanate (Ba, Sr)TiO₃, titanium oxide (TiO₂), niobium oxide (Nb₂O₅), tantalum pentoixde (Ta₂O₅) and a combination thereof. The dielectric layer 22 may be formed by the ALD process, the CVD process or the sputtering process. When the dielectric layer 22 is formed by the ALD process, ozone (O₃), vapor (H₂O) or oxygen (O₂), plasma may be used as an oxidization source. Hereinafter, it is assumed that the dielectric layer 22 is a zirconium oxide (ZrO₂) layer.

A ruthenium containing layer 23 is formed to be used as an upper electrode over ZrO₂ layer 22. The ruthenium containing layer 23 includes a ruthenium (Ru) or a ruthenium oxide (RuO₂) layer. The ruthenium, containing layer 23 has a greater work function than that of the TiN layer or a tungsten nitride (WN) layer. The Ru layer or the RuO₂ layer used as the ruthenium containing layer 23 is formed by the ALD process, the CVD process or the sputtering process, When the Ru layer, or the RuO₂ layer is formed by the ALD process or the CVD process, Ru(Cp)₂, Ru(MeCp)₂, Ru(EtCp)₂, Ru(Od)₃ or DER((2,4-Dimethylpetadienyl)(Ethylcyclopentadienyl)Ruthenium)) may be used as a ruthenium source material and O₂ gas, O₃ gas, O₂ plasma, NH₃ gas or H₂ gas may be used as a reaction gas. When forming the ruthenium containing layer 23 is performed by the ALD process, the temperature is maintained between approximately 250° C. to approximately 350° C. in order to prevent deoxidization of the ZrO₂ layer 22. Especially, when the NH₃ gas or the H₂ gas is used as the reaction gas, the temperature should be less than approximately 350° C., for example, ranging from approximately 250° C. to approximately 350° C. When the Ru layer or the RuO₂ layer is formed, a thickness of the Ru layer or the RuO₂ layer may be controlled to a range from approximately 100 Å to approximately 500 Å.

Since the Ru layer or the RuO₂ layer has a greater work function comparing to the TiN layer, in the case the Ru layer or the RuO₂ layer is used as an electrode over the ZrO₂ layer 22, it maintains a low leakage current of the capacitor. The ruthenium containing layer 23 is referred to as a ruthenium based electrode since it is used as an electrode of the capacitor. Hereinafter, it is assumed that the ruthenium containing layer 23 is the ruthenium layer.

A hard mask pattern 24 is formed over the ruthenium, layer 23. The hard mask pattern 24 includes a tungsten containing layer, such as a tungsten nitride (WN) layer. The tungsten nitride layer 24 is also used as an etch barrier during etching of the ruthenium layer 23. Further, since the WN layer 24 is conductive, it may be used as an upper electrode. Thus, the upper electrode may have a double structure of the ruthenium layer 23 and the WN layer 24.

The WN layer 24 is formed by the ALD process, the CVD process or the sputtering process. In the meantime, it is effective to form the WN layer 24 by using an ALD process when forming a capacitor of a three-dimensional (3D) structure having a great aspect ratio. The temperature during forming the WN layer 24 should be maintained at least under approximately 350° C., desirably ranging from approximately 200° C. to approximately 350° C., in order to prevent deterioration of the ZrO₂ layer 22 characteristics which is caused by the NH₃ gas. When the temperature during the formation of the WN layer 24 is maintained over approximately 350° C., the NH₃ gas used as the reaction gas may percolate through the ruthenium layer 23 and deoxidize the ZrO₂ layer 22. Therefore, the temperature should be maintained under approximately 350° C.

The tungsten nitride layer 24 may be formed by the ALD process. When the tungsten nitride layer 24 is formed by the ALD process, the temperature may be controlled between approximately 200° C. approximately 350° C. The tungsten nitride layer 24 has a thickness ranging from approximately 100 Å to approximately 500 Å. Further, when the tungsten nitride layer 24 is formed by the ALD process, the NH₃ gas may be used as the reaction gas and a tungsten hexafluoride (WF₆) gas may be used as a source gas. Further, a B₂H₆ gas may be added to increase absorption of the WF₆ gas.

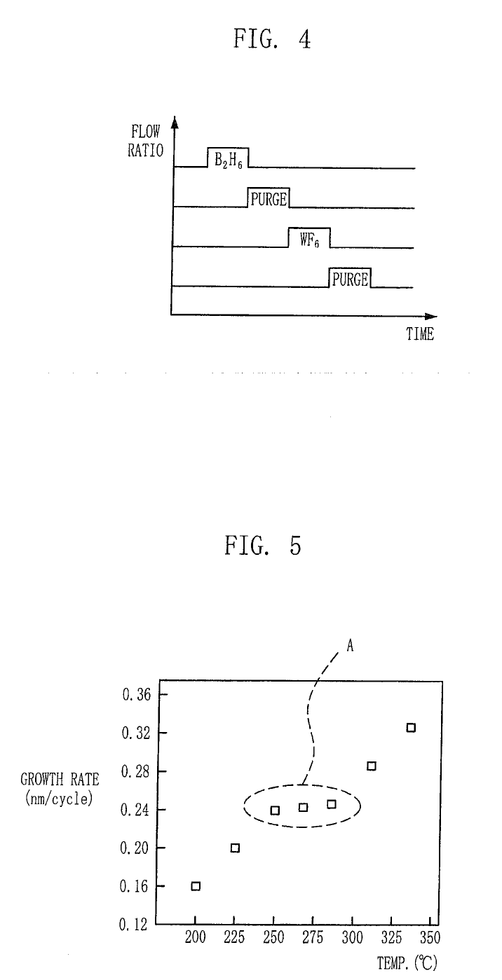

There is shown in FIG. 4 an order of gases injected into a chamber when forming the tungsten nitride layer by the ALD process. Referring to FIG. 4, the gases are injected in the order of; the B₂H₆ gas, a purge gas, the WF₆ gas, the purge gas, the NH₃ gas and the purge gas. The purge gas includes an inert gas, such an Ar gas or a nitrogen (N₂) gas.

Referring to FIG. 3B the tungsten nitride layer 24 is selectively etched by using a photoresist pattern (not shown), thus forming an etched tungsten nitride layer 24A. Then, the ruthenium layer 23 is selectively etched using the etched tungsten nitride layer 24A as an etch barrier, While the ruthenium layer 23 is etched, an etch gas 25 is used. The etch gas 25 includes one selected from a group consisting of an O₂ gas, a chlorine (Cl₂) gas and a combination thereof. Since the etched tungsten nitride layer 24A is conductive, the etched tungsten nitride layer 24A may be used as the upper electrode in company with the ruthenium layer 23.

FIG. 5 illustrates a growth rate of the tungsten nitride layer according to a substrate temperature during forming the tungsten nitride layer. Herein, when the tungsten nitride layer 15 formed by the ALD process, a temperature for the ALD process ranges from approximately 275° C. to approximately 300° C., referring to a part A in FIG. 5. In the meantime, when a titanium nitride (TiN) layer is formed by a chemical vapor deposition (CVD) process, a temperature higher than approximately 600° C. is needed. Further, although the titanium nitride layer is formed by the ALD process, a temperature higher than approximately 450° C. is required.

In the meantime, when the titanium nitride layer is formed as a hard mask pattern over the ruthenium layer, since the ruthenium layer is exposed at a temperature of approximately 450° C. or more in the NH₃, gas atmosphere, electrical characteristics of a dielectric layer may be deteriorated due to deoxidization of the dielectric layer under the ruthenium layer. However, when the tungsten nitride layer is formed over the ruthenium layer to act as an etch barrier of the ruthenium layer, although forming of the tungsten nitride layer is performed with the NH₃ gas (the same as forming the titanium nitride layer), it may not affect the dielectric layer since it is performed at a low temperature of 350° C. or less.

That is, when the tungsten nitride layer is formed over the ruthenium layer, an equivalent oxide thickness of the capacitor may be decreased since the tungsten nitride layer is not only acting as an etch barrier of the ruthenium layer but also preventing characteristics of the dielectric layer from being deteriorated.

In accordance with an embodiment of the presents invention, a ruthenium-based layer is etched with a tungsten nitride layer as a hared mask. The tungsten nitride layer can be formed at a low temperature to control deoxidization of a dielectric layer, which allows the leakage current characteristics of the dielectric layer under the ruthenium containing layer to be improved. Furthermore, since a double layer of the ruthenium containing layer and the tungsten nitride layer is applied to an upper electrode, a dynamic random access memory (DRAM) capacitor of 50 nm or less can be formed by improving the leakage current characteristics of the dielectric layer.

While the present invention has been described with respect to the specific embodiments, the above embodiment of the present invention is illustrative and not limitative. It will be apparent to those skilled in the art that various changes and modifications may be made without departing from the spirit and scope of the invention as defined in the following claims.

What is claimed is:

1. A capacitor, comprising:
a lower electrode;
a dielectric layer over the lower electrode; and
an upper electrode having a stack structure including a ruthenium-containing layer and a tungsten-containing layer over the dielectric layer.

2. The capacitor of claim 1, wherein the ruthenium-containing layer contacts the dielectric layer and the tungsten-containing layer is formed over the ruthenium-containing layer.

3. The capacitor of claim 1, wherein the ruthenium-containing layer comprises a ruthenium (Ru) layer or a ruthenium oxide (RuO₂) layer.

4. The capacitor of claim 1, wherein the tungsten-containing layer comprises a tungsten nitride (WN) layer.

5. The capacitor of claim 1, wherein each of the ruthenium-containing layer and the tungsten-containing layer has a thickness ranging from approximately 100 Å to approximately 500 Å.

6. The capacitor of claim 1, wherein the lower electrode comprises one selected from a group consisting of titanium nitride (TiN), Ru, RuO₂, platinum (Pt), iridium (Ir), iridium oxide (IrO₂), hafnium nitride (HfN), zirconium nitride (ZrN) and a combination thereof.

7. The capacitor of claim 1, wherein the dielectric layer comprises one selected from a group consisting of zirconium oxide (ZrO₂), hafnium oxide (HfO₂), aluminum oxide (Al₂O₃), strontium titanate (SrTiO₃), barium-strontium titanate (Ba, Sr)TiO₃, titanium oxide (TiO₂), niobium oxide (Nb₂O₅), tantalum pentoixde (Ta₂O₅) and a combination thereof.

8. A method for fabricating a capacitor, the method comprising:
forming a lower electrode;
forming a dielectric layer over the lower electrode;
forming a ruthenium-containing layer over the dielectric layer;
forming a hard mask pattern containing tungsten (W) over the ruthenium-containing layer; and
partially etching the ruthenium-containing layer using the hard mask pattern as an etch barrier, thereby forming an upper electrode.

9. The method of claim 8, wherein forming of the hard mask pattern comprises:
forming a tungsten-containing layer over the ruthenium-containing layer;
forming a photoresist pattern over the tungsten-containing layer; and
etching the tungsten-containing layer using the photoresist pattern as an etch barrier to form the hard mask pattern.

10. The method of claim 9, wherein the tungsten-containing layer comprises a tungsten nitride layer.

11. The method of claim 10, wherein the tungsten nitride layer is formed by an atomic layer deposition (ALD) process.

12. The method of claim 10, wherein the tungsten nitride layer is formed by a chemical vapor deposition (CVD) process or a sputtering process.

13. The method of claim 10, wherein the tungsten nitride layer is formed at a temperature ranging from approximately 200° C. to approximately 350° C.

14. The method of claim 11, wherein the ALD process is performed by injecting gases in an order of a diborate (B₂H₆) gas, a purge gas, a tungsten hexafluoride (WF₆) gas, the purge gas, an ammonia (NH₃) gas and the purge gas.

15. The method of claim 8, wherein the ruthenium-containing layer comprises a Ru layer or a RuO₂ layer.

16. The method of claim 15, wherein the ruthenium-containing layer is formed by a ALD process, a sputtering process or a CVD process.

17. The method of claim 16, wherein forming the ruthenium-containing layer is performed at a temperature ranging from approximately 250° C. to approximately 350° C.
